(19) United States
(12) Patent Application Publication
(10) Pub. No.: US 2008/0257695 A1
(43) Pub. Date: Oct. 23, 2008

(54) Air-electrical switch

(76) Inventor: Scott Noble Hickman, Ventura, CA (US)

Correspondence Address: DLA PIPER US LLP, 2000 UNIVERSITY AVENUE, E. PALO ALTO, CA, 94303-2248, US

(21) Appl. No.: 11/787,479

(22) Filed: Apr. 17, 2007

(51) Int. Cl. H01H 9/06

(52) U.S. Cl. 200/61.86

(57) ABSTRACT

A combined electrical switch and pneumatic valve device is provided in which the device controls the electrical switch and pneumatic valve simultaneously. In an exemplary embodiment, the device is used for a tire repair system.

### FIELD OF THE INVENTION

This invention relates to a combination electrical on/off switch and air control valve.

### BACKGROUND OF THE INVENTION

Several designs exist for injecting air and a fluid into a tire through a tire valve such as to repair and inflate the tire. Most of these designs pressurize a sealant container with sealant fluid and containing a compressor and then the relatively high pressure air forces the sealant fluid through an outlet tube and into a tire, sealing and inflating the tire simultaneously from a user perspective. These devices typically allow the user to inject air only or air/sealant into the tire. Unfortunately, a user may forget to attach the device to the tire before turning the device on or may have a valve set to “sealant/air dispense mode” when intending to only air inject air into their tire without sealant. In both cases, the device may does not function properly (from the user's perspective) and the user becomes frustrated.

It is desirable to provide a device that eliminates the problems associated with customer confusion due to multiple switches and valves on the device. The current state of the art in so-called automatic tire sealant dispensers usually uses a set of air connectors and the user must connect or disconnect air from a sealant container. When connected to a compressed air supply, the sealant container dispenses sealant. When disconnected, the system only provides air for normal tire inflation. Other designs attempt to use a valve to direct air to or away from a sealant dispenser. However, the user can be confused because they must also actuate an electrical on/off switch or users sometimes assume that simply pressing the on/off (electrical) switch will automatically dispense air or sealant/air. This confusion often results in sealant spraying all over the user. Thus, it is desirable to provide a combined electrical and air switch that overcomes these problems and it is to this end that the present invention is directed.

### SUMMARY OF THE INVENTION

A combined electrical switch and air valve device is provided that reduces user confusion when operating a device that provides either air or air and fluid to inflate and/or repair a tire. The device leads to better ease of use, less overall parts, lower cost, higher reliability, and most importantly, increased customer satisfaction. In the device, an electrical switch may be actuated at the same time as a pneumatic valve wherein the device has a single control (such as a knob) mechanism that, when manipulated by the user, actuates both an electrical connection to an electric motor driven air compressor as well as a valve that re-directs the output high pressure air from the compressor to the desired function. The device may incorporate graphics and labels on the surface of the product that clearly and simply allow the user to operate the device properly and without the typical user confusion.

### BRIEF DESCRIPTION OF THE DRAWINGS

FIG. 1 shows a cut-away outside plan view of an embodiment of a combined switch device with the electrical switch and air valve;

FIG. 2 shows an isometric view of the actual components accomplishing the electrical and pneumatic actuation of the combined switch device shown in FIG. 1;

FIG. 3 shows the same view as FIG. 1 without the product's outer case;

FIGS. 4 and 5 show the same view as FIG. 3, but with the knob in different positions;

FIG. 6 shows another embodiment of the combined switch device without the product's outer case and with the electrical switch in an off position;

FIG. 7 shows the embodiment of the device of FIG. 6 with the electrical switch in the on position; and

FIG. 8 illustrates an example of a integrated compressor device that may incorporate the combined switch device shown in FIGS. 1-7.

### DETAILED DESCRIPTION OF EXEMPLARY EMBODIMENTS

The combined switch device is particularly applicable to a device for tire repair that can dispense compressed air (to inflate a tire) or compressed air with sealant fluid to repair and then inflate the tire wherein the combined switch device is useful to electrically actuating a compressor pump that uses an electric motor and actuate a air valve to direct compressed air from the pump to either a tire sealant/air dispensing/inflation device, or directly to a tire to inflate without sealant and it is in this context that the combined switch device will be described. It will be appreciated, however, that the combined switch device has greater utility since it is useful in any product that includes an electrical on/off switch and an air valve such as a compressor using an electric motor to drive a pump and it not limited to use in the tire repair context.

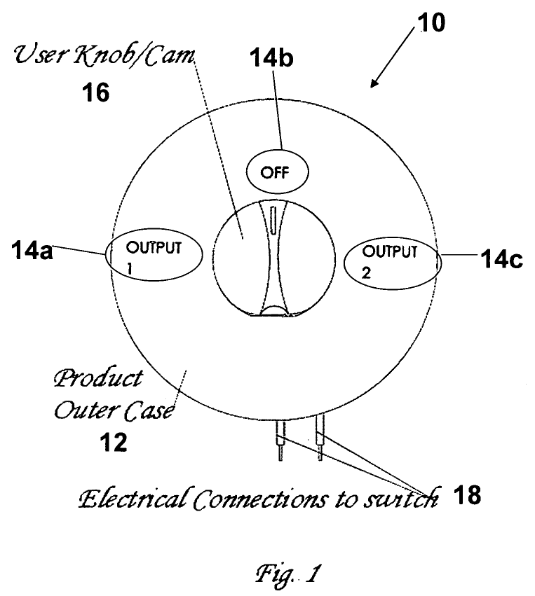

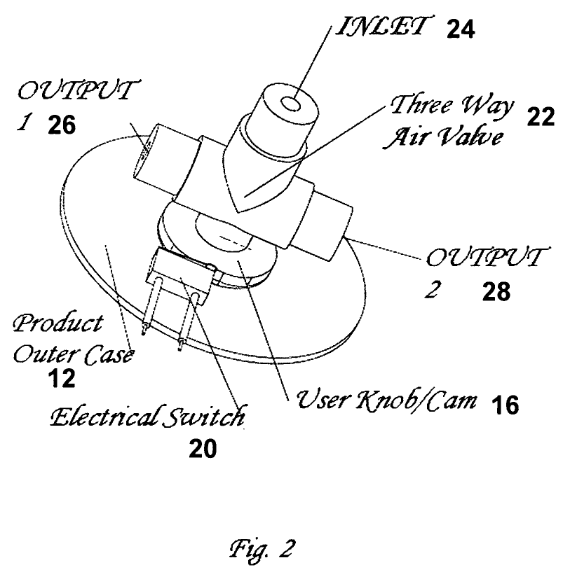

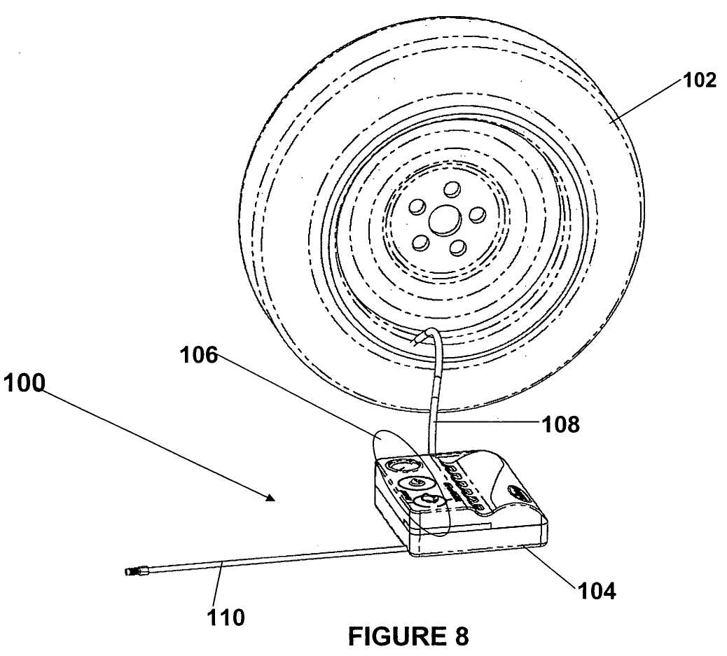

FIG. 1 shows a cut-away outside plan view of an embodiment of a combined switch device 10 with the electrical switch and air valve. The combined switch device 10 may be mounted on an outer case 12 of a product, such as the tire repair apparatus shown in FIG. 8, and may include a set of indicia 14 on the outer case, such as “Output 1” 14a, “OFF” 14b and “Output 2” 14c as shown in FIG. 1. The combined switch device 10 may also have a control element 16, such as a knob or button, that is rotatable or slidable by the user to select a particular function of the product associated with the device. The combined switch device 10 may also have a set of electrical leads 18 that lead from an electrical switch 20 of the combined switch device shown in FIG. 2. In operation, the user may rotate the control element between a set of control positions, such as Output 1, Output 2 and Off in the example in FIG. 1, to control the operation of the product using the combined switch device. In the example shown in FIG. 1, the tire repair/inflation product (described below with reference to FIG. 8) may be in an OFF state (in which the electrical switch if disengaged and the air valve is closed), an Output 1 state (in which the electrical switch is engaged and the air valve allows air to flow to the first output that may provide air directly to the tire to inflate the tire) and an Output 2 state (in which the electrical switch is engaged and the air valve allows air to flow to the second output that may provide air to a sealant container that contains sealant fluid so that compressed air and sealant fluid are injected into the tire to repair and inflate the tire). In the operation, the single control element actuated by the user can be used to engage/disengage an electrical switch and actuate a valve. In the tire repair product, the combined switch device reduces/eliminates user confusion and error when using the tire repair product.

FIG. 2 shows an isometric view of the actual components accomplishing the electrical and pneumatic actuation of the device 10 shown in FIG. 1. As shown in FIG. 2, the device 10 have the electrical switch 20 (with a switch body) and an air valve 22. In the exemplary embodiment shown in FIG. 2, a three way valve with an air inlet 24 and two air outlets 26, 28 is used that may be a common off-the-shelf three way air valve. However, the device 10 may also be used with a valve that may be any design such as a three way or multi-way air valve.

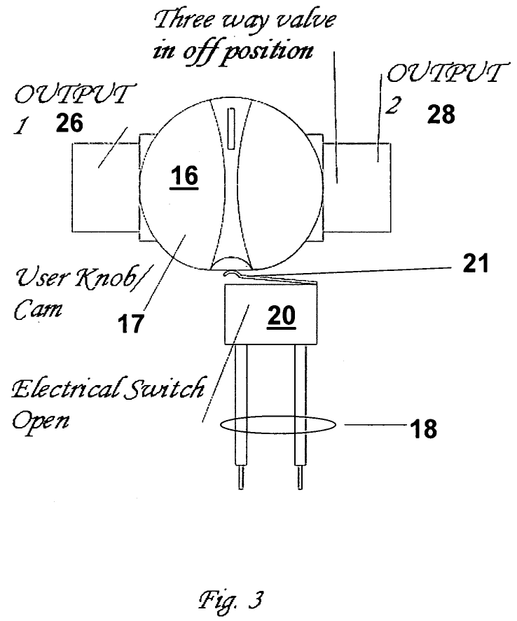

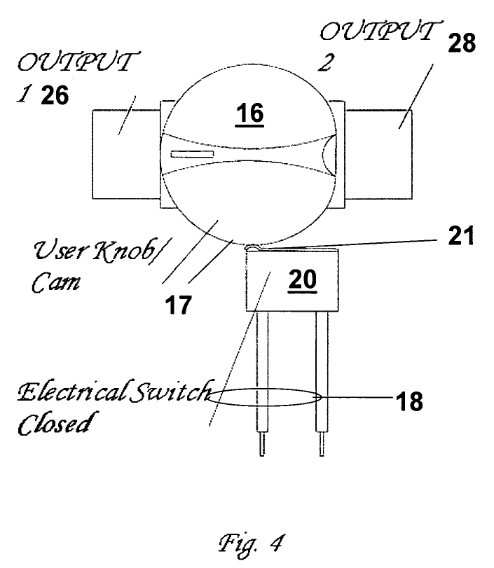

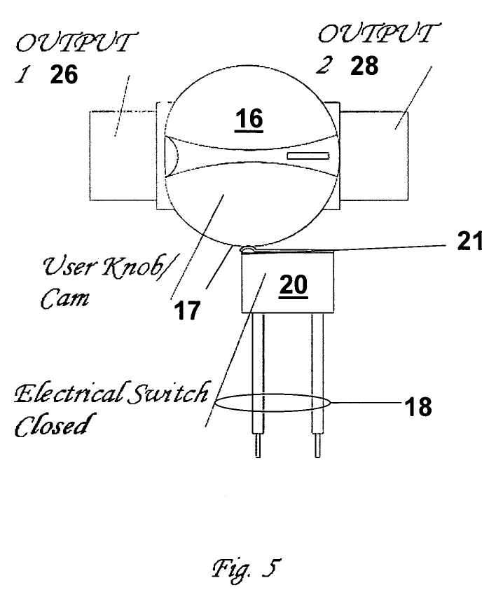

FIGS. 3-5 show the device 10 in an OFF position (FIG. 3), an ON position with air output to output 1 (FIG. 4) and an ON position with air output to output 2 (FIG. 5). When the device is OFF, the electrical switch 20 (with a contact 21) is disengaged and the contact is not touching the electrical switch and the valve is closed. The control element 16 may have one or more control/cam regions 17 wherein, as the control element is rotated to an ON position, the cam regions (shown in FIGS. 4 and 5) press the contact 21 against the electrical switch 20 and engage the electrical switch. The rotation of the control element 16 also actuates the valve to direct air from the inlet 24 to the first or second output 26, 28 depending on the position of the control element.

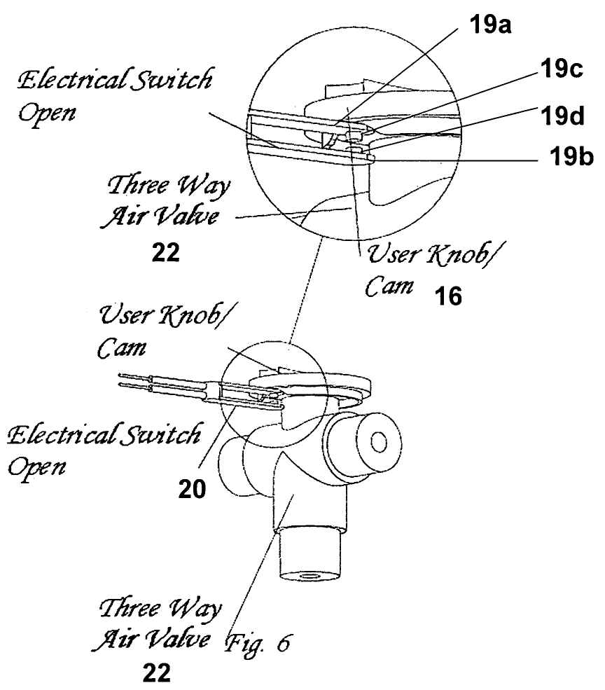

FIG. 6 shows another embodiment of the combined switch device 10 without the product's outer case and with the electrical switch in an off position. In this embodiment, like elements have like reference numerals and like operation. In this embodiment, the electrical switch 20 may be a device that is engaged or disengaged by pressed together a contact on a set of fingers as shown and the control element may have a lower region 19a and control regions 19b wherein the control regions cause the contacts of the set of fingers to contact each other and therefore engage the electrical switch. Otherwise, this embodiment of the combined switch device operates in the same manner as the prior embodiment.

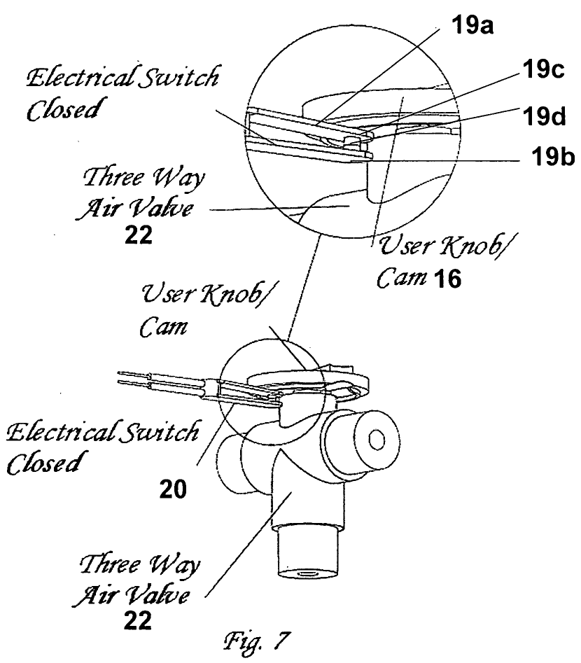

FIG. 8 illustrates an example of an integrated compressor device 100 that may incorporate the combined electrical and air valve switch 10 shown in FIGS. 1-7. The device 100 may be used to seal and/or inflate an object 102, such as an automobile tire. The device 100 may include a housing 104 that houses an gas compressor and a sealant container that contains a sealant that may be propelled into the inflatable object 102 in order to repair a puncture in the inflatable object 102. The preferred gas compressor is a small 12V DC gear-driven, piston-type compressor. The device may also use 12V DC motor direct drive piston-type compressors, 120V AC powered compressors, and diesel motor driven truck air compressors. The device 100 may further include a set of controls 106 on the housing that control the operation of the device wherein at least one of the controls is the combined switch device 10. The device 100 also may have a first hose 108 and a second hose 110 wherein the first hose 108 may inject compressed gas, such as air, and the sealant in the sealant container into the inflatable object in order to repair the inflatable object and re-inflate the inflatable object. The second hose 110 may inject the compressed gas into the inflatable object to re-inflate the inflatable object. Thus, the device 100 may be used in a mode of operation in which air and sealant are injected into the inflatable object as shown in FIG. 1 or a mode of operation in which compressed air from the compressor is injected into the inflatable object as shown in FIG. 2. The device is powered from a 12V DC power source, preferably a car accessory power adapter or 12V lead acid battery and receptacle adapter. Other power sources may include 120 V AC, or other compressed air generators or storage tanks. The device 10 may use any type of sealant. Preferably, the device 10 may use the Slime brand sealant commercially sold by Accessories Marketing, Inc. (www.slime.com) The first hose 18, which is the sealant and air hose, may include a screw valve located at the end of the hose that connects to a tire. The screw valve opens when attached to a tire and closes when disconnected from the tire to prevent spray and dripping of the sealant fluid.

While the foregoing has been with reference to a particular embodiment of the invention, it will be appreciated by those skilled in the art that changes in this embodiment may be made without departing from the principles and spirit of the invention, the scope of which is defined by the appended claims.

1. A combined switch device, comprising:
a product;
a switch element that is part of the product, the switch element comprising a control element, an electrical switch coupled to the control element and a valve coupled to the control element wherein the electrical switch and valve are actuated when the control element is actuated.

2. The device of claim 1, wherein the control element is a rotatable knob.

3. The device of claim 2, wherein the switch element has an off position in which the electrical switch and valve are not actuated, a first output position in which the electrical switch is actuated and the valve establishes a conduit to a first output and a second output position in which the electrical switch is actuated and the valve establishes a conduit to a second output, and wherein the off position, the first output position and the second output position are selectable using the control element.

4. The device of claim 3, wherein the product has an off position indicia, a first output position indicia and a second output position indicia on an outer portion of the product that correspond to the off position, the first output position and the second output position of the switch element.

5. The device of claim 4, wherein the valve in a multi-way valve.

6. The device of claim 3, wherein the control element has a control region that actuates the electrical switch in the first and second output positions.

7. The device of claim 6, wherein the electrical switch further comprises a switch body and a contact wherein the contact is pressed against the switch body by the control region when the electrical switch is actuated.

8. The device of claim 6, wherein the electrical switch further comprises a switch body and a pair of fingers that each have a contact wherein the contacts of the pair of fingers are pressed together by the control region when the electrical switch is actuated.

9. The device of claim 5, wherein the multi-way valve is a three way valve.

10. The device of claim 1, wherein the product is a tire repair product.
